(19) United States
(12) Patent Application Publication
(10) Pub. No.: US 2003/0013480 A1
(43) Pub. Date: Jan. 16, 2003

(54) Mobile station and frequency band detection method

(75) Inventor: Etsuro Endo, Tokyo (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/191,059

(22) Filed: Jul. 10, 2002

(30) Foreign Application Priority Data
Jul. 11, 2001 (JP) 210407/2001

(51) Int. Cl. H04B 1/00

(52) U.S. Cl. 455/552; 455/434; 455/553; 455/575

(57) ABSTRACT

A mobile station and frequency band detection method in a mobile communication system in which a base station communicates with a mobile station in one of a plurality of set frequency bands. In this detection method, when a frequency band of a radio signal from a base station is to be detected, detection of a frequency band which was used in the past for actual communication with any of base stations or a predetermined frequency band is performed before detection of other frequency bands.

### BACKGROUND OF THE INVENTION

1. Field of the Invention

The present invention relates to a mobile station in a mobile communication system and, more particularly, to a mobile station which communicates with a base station in one of a plurality of frequency bands prepared for communication and a frequency band detection method.

2. Description of the Prior Art

Recently, mobile communication systems such as a portable telephone system have become widespread.

In such a mobile communication system, radio communication is performed between a mobile station, i.e., a portable telephone apparatus or radio portable terminal apparatus and a base station connected to a telephone network, thereby allowing communication with another telephone set or communication apparatus connected to the telephone network.

Radio communication between a mobile station and a base station is realized by transmitting/receiving signals upon modulating them in a predetermined frequency band.

One of the communication schemes used by such mobile communication systems is CDMA (Code Division Multiple Access).

According to CDMA, on the transmitting side, data is spread by using one of predetermined spreading codes which differ depending on the data to be transmitted, and the spread data is transmitted. On the receiving side, the data is obtained by spreading (so-called despreading) the reception signal by using a spreading code identical to the one used on the transmitting side (to be precise, a code complex conjugate to the spreading code on the transmitting side). In such communication based on CDMA, the peak correlation value of a signal received on the receiving side is found out by shifting the despreading timing, thereby regenerating the signal transmitted from the transmitting side.

In an actual communication environment for such a mobile communication system, a plurality of frequency bands for communication are set (prepared), and communication between a base station and a mobile station is done in one of these frequency bands.

As these frequency bands for communication, for example, different frequency bands are used for the respective base stations. A mobile station selects a signal in the frequency band, of the plurality of frequency bands, which is used by a base station in an area where the user currently exists, and uses the frequency for communication. In the W (Wide-band)-CDMA scheme, if different spread signals are used in the respective base stations, all the base stations need not necessarily use different frequency bands. However, since a carrier in an area where the user is present may use a frequency band different from that used by another carrier, communication needs to be performed upon selection of a signal in the frequency band used by the base station in the area where the user is currently present.

Under the circumstances, since a conventional mobile station cannot know to which one of a plurality of frequency bands set in the mobile communication system the frequency band used in a base station in an area where the user is currently present corresponds, the mobile station sequentially performs receiving operation for all the frequency bands set in the mobile communication system to detect the presence/absence of a radio signal, and determines a frequency band used for communication.

For this reason, the conventional mobile station must sequentially search all frequency bands set in the mobile communication system until it can communicate with a base station. It takes much time to find a frequency band to be used.

If the number of frequency bands used for communication is large, a very long period of time is required to search them. For this reason, a conventional mobile station requires a long period of time to become operable after the mobile station is powered on, resulting in poor operability for the user.

### SUMMARY OF THE INVENTION

The present invention has been made in consideration of the above problem, and has as its object to shorten the time required to find a frequency band to be used in a mobile station which communicates with a base station in one of a plurality of frequency bands.

In order to achieve the above object, according to the first main aspect of the present invention, there is provided a mobile station in a mobile communication system in which a base station communicates with a mobile station in one of a plurality of set frequency bands, wherein when a frequency band of a radio signal from a base station is to be detected, detection of a frequency band which was used in the past for actual communication with any of base stations is performed before detection of other frequency bands.

In the first aspect, the frequency band used in the past for actual communication with any of base stations can be a frequency band that was used in immediately preceding communication.

In order to achieve the above object, according to the second main aspect of the present invention, there is provided a mobile station in a mobile communication system in which a base station communicates with a mobile station in one of a plurality of set frequency bands, wherein when a frequency band of a radio signal from a base station is to be detected, detection of a predetermined frequency band is performed before detection of other frequency bands.

In the second aspect, the predetermined frequency band can be set when a user registers the frequency band.

In order to achieve the above object, according to the third aspect of the present invention, there is provided a mobile station in a mobile communication system in which a base station communicates with a mobile station in one of a plurality of set frequency bands, comprising an antenna which receives a radio signal from a base station, a radio section which extracts a component in a frequency band as a demodulation target of the radio signal received by the antenna, and a control section which indicates the frequency band as the demodulation target to the radio section, wherein when the control section indicates the frequency band to the radio section to detect a frequency band used for communication with a current base station, the control section indicates, to the radio section, a frequency band which was used in the past for actual communication with any of base stations, of the plurality of set frequency bands, before indicating other frequency bands.

In order to achieve the above object, according to the fourth aspect of the present invention, there is provided a mobile station in a mobile communication system in which a base station communicates with a mobile station in one of a plurality of set frequency bands, comprising an antenna which receives a radio signal from a base station, a radio section which extracts a component in a frequency band as a demodulation target of the radio signal received by the antenna, and a control section which indicates the frequency band as the demodulation target to the radio section, wherein when the control section indicates a frequency band to the radio section to detect a frequency band used for communication with a current base station, the control section indicates, to the radio section, a predetermined frequency band of the plurality of set frequency bands before indicating other frequency bands.

In the fourth aspect, the control section comprises registration means for registering a predetermined frequency band, and means for, when a frequency band is to be indicated to the radio section to detect a frequency band to be used for communication with a current base station, indicating a frequency band, of the plurality of frequency bands, which is registered in the registration means before indicating other frequency bands.

The mobile station in the fourth aspect further comprises input means for inputting predetermined information, and the registration means registers a frequency band corresponding to information input by the input means.

In order to achieve the above object, according to the fifth aspect of the present invention, there is provided a mobile station in a mobile communication system in which a base station communicates with a mobile station in one of a plurality of set frequency bands, comprising an antenna which receives a radio signal from a base station, a radio section which extracts a component in a frequency band as a demodulation target of the radio signal received by the antenna, a control section which indicates the frequency band as the demodulation target to the radio section, and a nonvolatile storage section which stores a frequency band which was used in the past for actual communication with any of base stations, wherein when the control section indicates a frequency band to the radio section to detect a frequency band used for communication with a current base station, the control section indicates, to the radio section, the frequency band of the plurality of frequency bands which is stored in the storage section, before indicating other frequency bands.

In order to achieve the above object, according to the sixth aspect of the present invention, there is provided a mobile station in a mobile communication system in which a base station communicates with a mobile station in one of a plurality of set frequency bands, comprising an antenna which receives a radio signal from a base station, a radio section which extracts a component in a frequency band as a demodulation target of the radio signal received by the antenna, a control section which indicates the frequency band as the demodulation target to the radio section, and a nonvolatile storage section which stores a predetermined frequency band, wherein when the control section indicates a frequency band to the radio section to detect a frequency band used for communication with a current base station, the control section indicates, to the radio section, the frequency band of the plurality of frequency bands which is stored in the storage section, before indicating other frequency bands.

The control section in the fifth or sixth aspect detects whether a frequency band is stored in the storage section, when indicating a frequency band to the radio section to detect a frequency band used for communication with a current base station, controls the radio section to extract a component in a frequency band as a demodulation target with respect to the plurality of frequency bands when no frequency band is stored in the storage section, and causes the storage section to store the extracted frequency band.

The mobile station in the fifth aspect further comprises input means for inputting predetermined information, and the storage section can store a frequency band corresponding to the information input by the input means as well as a frequency band used in the past for actual communication with any of base stations.

The mobile station in the sixth aspect further comprises input means for inputting predetermined information, and the registration means registers a frequency band corresponding to information input by the input means.

In each aspect described above, the mobile communication system can be based on a CDMA scheme.

In order to achieve the above object, according to the seventh aspect of the present invention, there is provided a frequency band detection method of causing a mobile station in a mobile communication system in which a base station communicates with a mobile station in any of a plurality of set frequency bands to detect a frequency band of a radio signal from a base station, wherein detection of a frequency band, of the plurality of set frequency bands, which was used in the past for actual communication with any of base stations is performed before detection of other frequency bands.

In order to achieve the above object, according to the eighth aspect of the present invention, there is provided a frequency band detection method of causing a mobile station in a mobile communication system in which a base station communicates with a mobile station in any of a plurality of set frequency bands to detect a frequency band of a radio signal from a base station, wherein detection of a predetermined frequency band of the plurality of set frequency bands is performed before detection of other frequency bands.

As is obvious from the above aspects, according to the present invention, in a mobile station which communicates with a base station in one of a plurality of frequency bands, the time required tQ find a frequency band to be used can be shortened.

More specifically, when the frequency of a radio signal from a base station remains unchanged as in a case wherein the user is present in the same area as the area where the user previously used the mobile station, the radio signal can be immediately received. In this case, there is no need to check all frequencies that can be used in the mobile communication system, and the mobile station can be quickly used.

In addition, since log data about the frequency of a radio signal from a base station with which the mobile station of the user communicated in the past is stored, when, for example, the user is present in the same area as the area where the frequency recorded by this log data is used, the mobile station can quickly receive a radio signal from the base station. In this case, there is no need to check all frequencies that can be used in the mobile communication system, and the mobile station can be quickly used.

Furthermore, since the user can register areas by himself/herself, even if the user is present in an area where he/she did not use the mobile station in the past, he/she can quickly receive a radio signal from a base station by registering the area in the mobile station in advance. In this case, there is no need to check all frequencies that can be used in the mobile communication system, and the mobile station can be quickly used.

The above and many other objects, features and advantages of the present invention will become manifest to those skilled in the art upon making reference to the following detailed description and accompanying drawings in which preferred embodiments incorporating the principle of the present invention are shown by of illustrative examples.

### BRIEF DESCRIPTION OF THE DRAWINGS

FIG. 1 is a block diagram showing a schematic arrangement of a CDMA mobile communication system to which a mobile station according to the present invention is applied;

FIG. 2 is a block diagram showing a communication environment for the CDMA mobile communication system to which the mobile station shown in FIG. 1 is applied;

FIG. 3 is a block diagram showing an arrangement of the mobile station shown in FIG. 1;

FIG. 4 is a block diagram showing the internal arrangement of a radio section in FIG. 3;

FIG. 5 is a view for explaining the frequency band of radio signals transmitted from a base station;

FIG. 6 is a view showing the arrangement of contents stored in a memory in the mobile station according to the first embodiment of the present invention;

FIG. 7 is a flow chart showing the processing performed by the mobile station according to the first embodiment of the present invention;

FIG. 8 is a view showing the arrangement of contents stored in a memory in a mobile station according to the second embodiment of the present invention;

FIG. 9 is a flow chart showing the processing performed by the mobile station according to the second embodiment of the present invention;

FIG. 10 is a view showing the arrangement of contents stored in a memory in a mobile station according to the third embodiment of the present invention;

FIG. 11 is a flow chart showing the processing performed by the mobile station according to the third embodiment of the present invention, and more specifically, processing for registration in a user registration table in FIG. 10; and

FIG. 12 is a flow chart showing the processing performed by the mobile station according to the third embodiment of the present invention and, more specifically, the processing performed by the mobile station in detecting the frequency of a radio signal from a base station.

### DETAILED DESCRIPTION OF THE PREFERRED EMBODIMENTS

Several preferred embodiments of the present invention will be describe below with reference to the accompanying drawings.

The following description is based on the assumption that the present invention is applied to a mobile station in a CDMA mobile communication system.

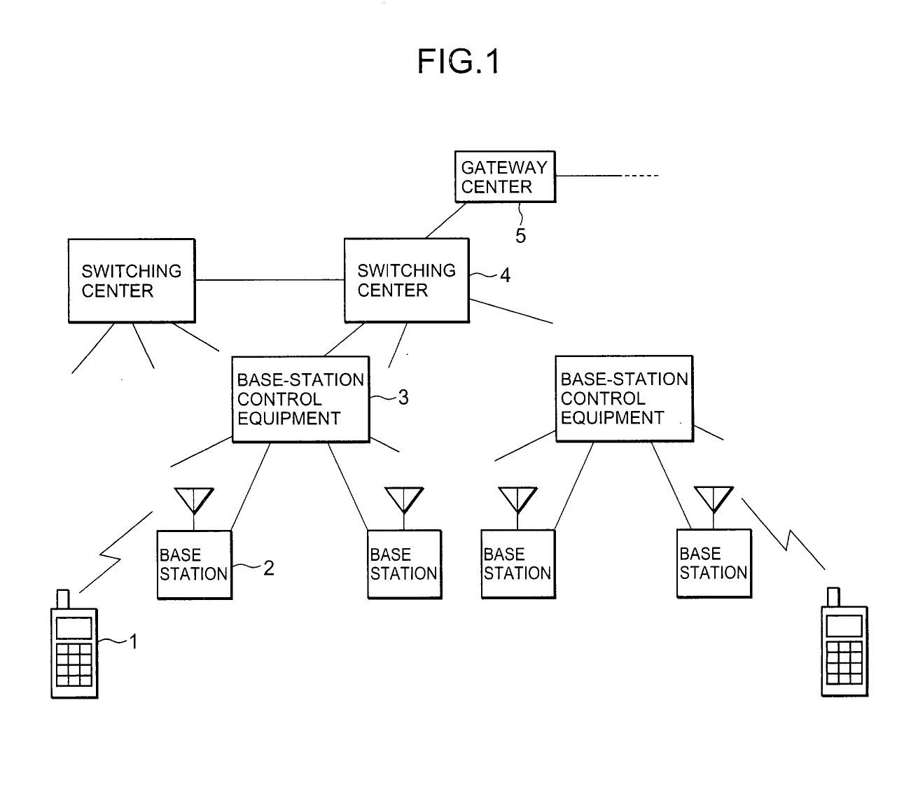

As shown in FIG. 1, ATM (Asynchronous Transfer Mode) communication techniques and the like have been applied to base stations, base station control equipments, and switching centers constituting a network for a mobile communication system in consideration of the diversification (trends toward multimedia) of services provided by the mobile communication system and the efficient use (statistical multiplexing) of transmission paths that connect the respective base stations, base station control equipments, and switching centers.

A mobile station 1 communicates with another mobile station in the mobile communication system, a terminal apparatus connected to another network, or the like. The mobile station 1 can perform various types of communications, e.g., speech communication and data communication.

Transmission data from the mobile station 1 is transmitted as communication data to a base station 2 by radio communication. The base station 2 performs various processes for the communication data received from the mobile station 1 or other mobile stations, e.g., assembling the data into ATM cells, and transmits the resultant data to a base station control equipment 3.

In this manner, base stations transmit information in the form of ATM cells within the network regardless of whether the communication data in a radio zone is speech data, image data, or data in other forms. This makes it possible to easily cope with multimedia communication forms.

The base station control equipment 3 routes the ATM cells received from the base station 2 for each user, and transmits them to switching centers 4 or other subordinate base stations. The switching center 4 routes the ATM cells received from the base station control equipment 3 for each user, and transmits them to other switching centers or a gateway center 5.

In such ATM cell transmission, ATM cells may be made to flow in a transmission path upon generation of the ATM cells. This obviates the necessity to prepare a transmission path for each predetermined channel in a conventional system. Therefore, a statistical multiplexing effect can be obtained, and transmission paths can be efficiently used. Note that the gateway center 5 is used to relay data to another network.

In transmitting data from the network side to the mobile station 1, the base station 2 performs primary modulation such as QPSK, then performs spread spectrum modulation as secondary modulation, and transmits the spread signal, whose spectrum is spread to a frequency bandwidth centered on a predetermined frequency (intermediate frequency). The mobile station 1 uses a demodulation circuit to demodulate the reception signal from the base station 2 by despreading it, thereby regenerating the data from the network side.

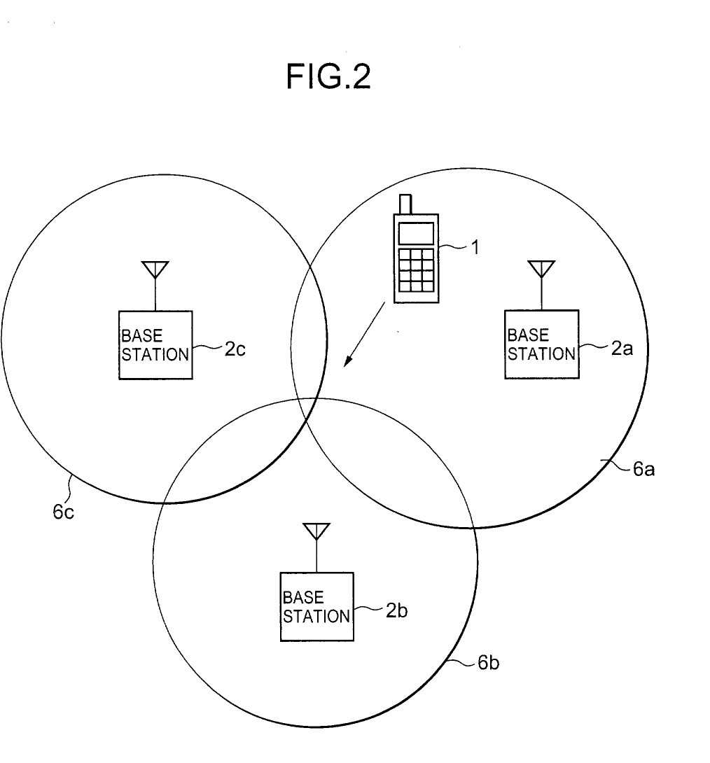

FIG. 2 is a block diagram showing a communication environment for the CDMA mobile communication system to which the mobile station 1 shown in FIG. 1 is applied.

The CDMA mobile communication system shown in FIG. 2 uses the cellular scheme. In this system, the range covered by a base station 2a is a cell 6a, the range covered by a base station 2b is a cell 6b, and the range covered by a base station 2c is a cell 6c.

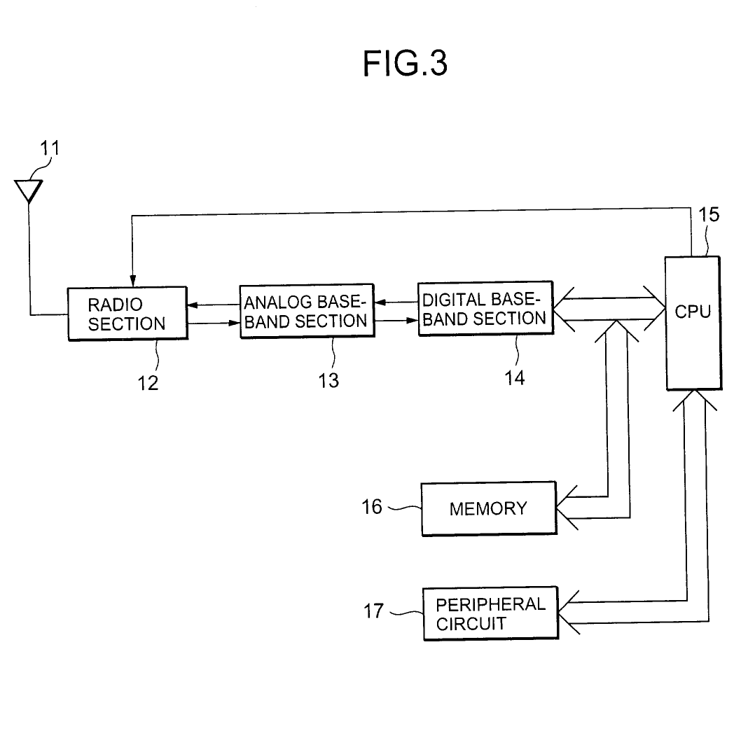

FIG. 3 is a block diagram showing an arrangement of the mobile station 1 shown in FIG. 1.

As shown in FIG. 3, the mobile station 1 is comprised of an antenna 11 for receiving a radio signal from a base station and transmitting a radio signal to a base station, a radio section 12 for, for example, demodulating a received radio signal and modulating a signal to be transmitted, an analog baseband section 13 for performing analog baseband processing, a digital baseband section 14 for performing digital baseband processing, a CPU 15 for controlling the overall station, a memory 16 which is a nonvolatile storage means storing various parameters and the like, and a peripheral circuit 17 having a microphone, receiver, operation input section, display section, and the like.

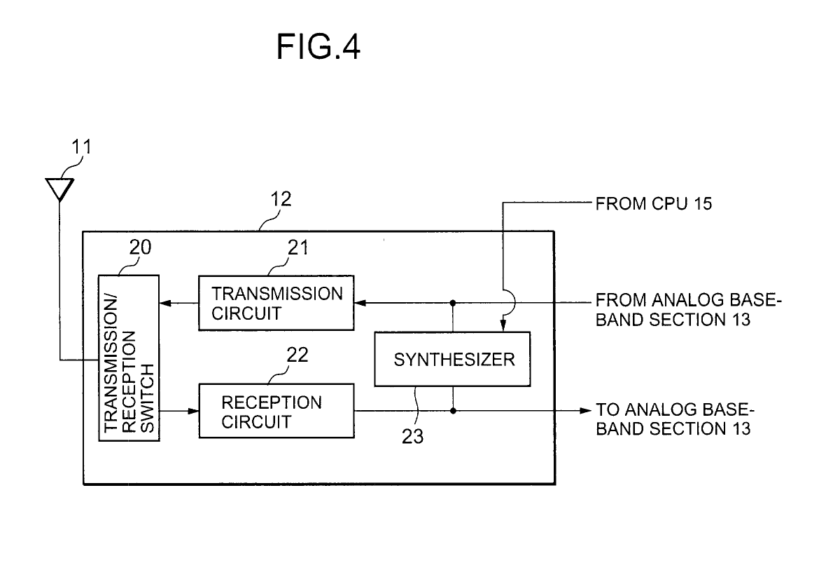

FIG. 4 is a block diagram showing the internal arrangement of the radio section 12 in FIG. 3.

As shown in FIG. 4, the radio section 12 is comprised of a transmission/reception switch 20 for switching between transmission and reception, a transmission circuit 21, a reception circuit 22, and a synthesizer 23 for generating a frequency for modulation or demodulation.

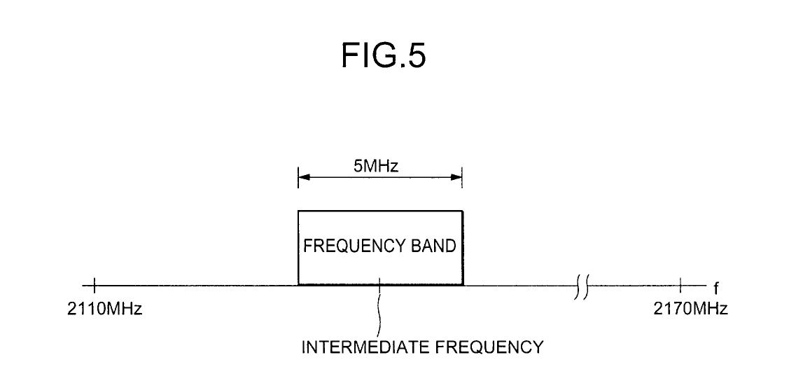

FIG. 5 is a view for explaining the frequency band of radio signals transmitted from a base station.

Consider a case wherein frequencies between 2,110 MHz and 2,170 MHz are allocated to the downlink side of the mobile communication system (communication from base stations to mobile stations), and a radio signal is transmitted from a base station after the spectrum of the signal is spread to a frequency bandwidth of 5 MHz, as shown in FIG. 5.

In this case, the number of frequencies which can be the intermediate frequency of a radio signal having undergone spread spectrum is as many as 300 when counted within the bandwidth from 2,112.4 MHz to 2,167.6 MHz in minimum increments of 0.2 MHz. Note that the frequencies between 2,110 MHz and 2,112.4 MHz and between 2,167.6 MHz and 2,170 MHz cannot be intermediate frequencies because each frequency bandwidth is 5 MHz.

Different carriers may use different frequency bands in base stations, and different countries may also use different frequency bands. For this reason, the mobile station 1 must sequentially check all the frequencies, whose number reaches as many as 300, whether a radio signal can be detected. In the prior art, this takes much time. The present invention is aimed at shortening this time.

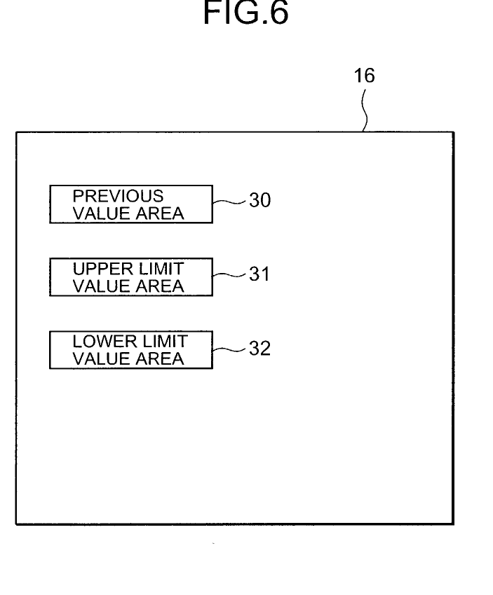

FIG. 6 shows the arrangement of contents stored in the memory 16 in FIG. 3.

In this embodiment, as shown in FIG. 6, a previous value area 30, upper limit value area 31, and lower limit value area 32 are set in the memory 16 In the previous value area 30, the intermediate frequency in the frequency band used when the mobile station 1 previously communicated with a base station is stored. In the upper limit value area 31, the upper limit frequency (2,167.6 MHz in this case) which can be an intermediate frequency specified in the mobile communication system is stored. In the lower limit value area 32, the lower limit frequency (2,112.4 MHz in this case) which can be an intermediate frequency specified in the mobile communication system is stored.

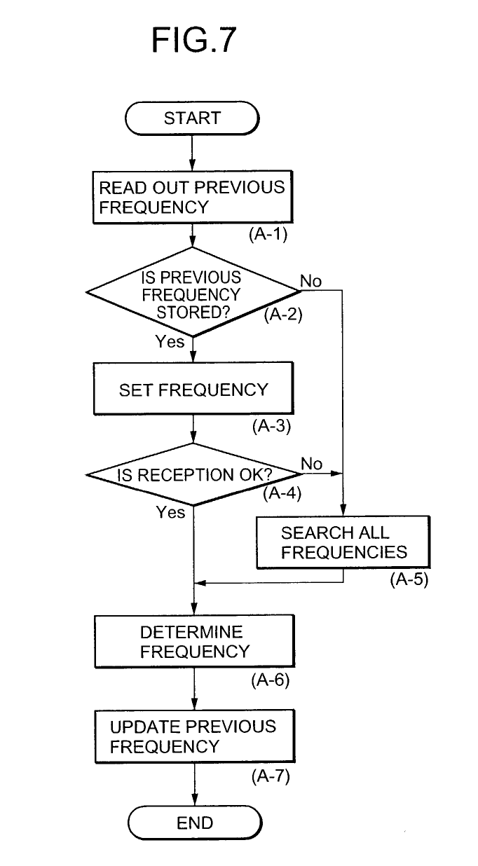

FIG. 7 is a flow chart showing processing performed by the mobile station 1 according to the first embodiment of the present invention.

First of all, when it is necessary to find the frequency band of radio signals from a base station as in a case wherein the mobile station 1 is powered on, the CPU 15 reads out the intermediate frequency used for previous communication from the previous value area 30 of the memory 16 (A-1).

If no value is stored in the previous value area 30 because, for example, no communication has been done before (A-2), the flow advances to step A-5 to perform all frequency search as described later.

If a previous frequency is obtained in step A-2, the CPU 15 indicates this value to the synthesizer 23 of the radio section 12 to try demodulation with this frequency (A-3). If a radio signal can be detected as a result of this operation (A-4), reception is continued in the corresponding frequency band (A-6).

If no radio signal can be detected in step A-4, the flow advances to step A-5 as in the case wherein no previous frequency is obtained in step A-2. In step A-5, an upper limit frequency and lower limit frequency are read out from the upper limit value area 31 and lower limit value area 32 of the memory 16, the CPU 15 indicates frequencies within this range with increments of 0.2 MHz, and tries demodulation with these frequencies. The CPU 15 repeats this search until a radio signal is detected. Any search method, e.g., upward search or downward search, can be used in this case. If the frequency of a radio signal is found in step A-5 as well, reception is continued with the corresponding frequency band (A-6).

In step A-7, the previous detected frequency is written in the previous value area 30 to prepare for the next operation. If a radio signal can be detected in step A-4, since the frequency band of radio signals from the base station has not changed from the previous frequency band, the processing in step A-7 may be omitted.

Another embodiment of the present invention will be described next.

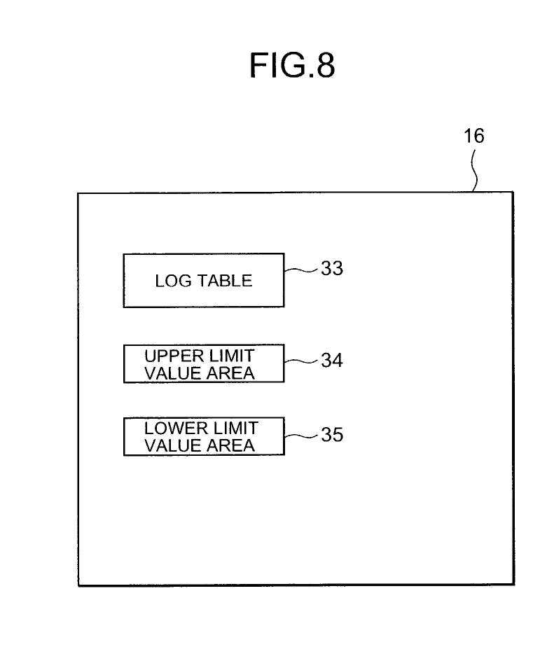

FIG. 8 is a view showing the arrangement of contents stored in a memory 16 in FIG. 3 in a mobile station according to the second embodiment of the present invention.

In this embodiment, as shown in FIG. 8, a log table 33, upper limit value area 34, and lower limit value area 35 are set in the memory 16.

If there are different intermediate frequencies in a frequency band used when the mobile station 1 communicated with a base station in the past, these frequencies are stored in the log table 33 in reverse chronological order. Although the number of frequencies that can be stored need not be specified, this number may be set in advance in the manufacturing stage or the user may be allowed to determine it.

In the upper limit value area 34, the upper limit frequency (2,167.6 MHz in this case) which can be an intermediate frequency specified in the mobile communication system is stored. In the lower limit value area 32, the lower limit frequency (2,112.4 MHz in this case) which can be an intermediate frequency specified in the mobile communication system is stored.

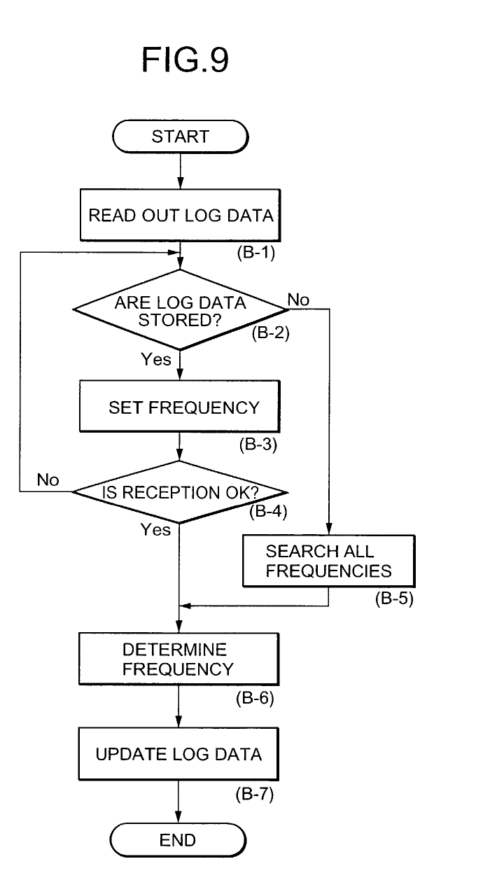

FIG. 9 is a flow chart showing the processing performed by the mobile station according to the second embodiment of the present invention.

First of all, when it is necessary to find the frequency band of radio signals from a base station as in a case wherein the mobile station 1 is powered on, a CPU 15 reads out log data from the log table 33 of the memory 16 (B-1).

If no log data is stored in the log table 33 because, for example, no communication has been done before (B-2), the flow advances to step B-5 to perform all frequency search as described later.

If log data is obtained in step B-2, the CPU 15 indicates the latest frequency of the log data to a synthesizer 23 of a radio section 12 and tries demodulation with this frequency (B-3). If a radio signal is detected (B-4), reception is continued with the corresponding frequency band (B-6).

If no radio signal is detected in step B-4, the flow returns to step B-2 to check whether there is any frequency left unchecked in the log data. If there are frequencies left unchecked in the log data, the CPU 15 indicates the latest frequency to the synthesizer 23 of the radio section 12 and tries demodulation with this frequency (B-3). If a radio signal is detected (B-4), reception is continued with this frequency band (B-6).

If it is determined in step B-2 that there is no frequency left unchecked in the log data, the flow advances to step B-5 as in the case wherein no log data is obtained.

In step B-5, as in step A-5 in FIG. 7, the CPU 15 reads out the upper and lower limit frequencies from the upper limit value area 34 and lower limit value area 35 of the memory 16, indicates frequencies in this range to the synthesizer 23 of the radio section 12 with increments of 0.2 MHz, and tries demodulation with these frequencies. This operation is repeated until a radio signal is detected. Any search method, e.g., upward search or downward search, can be used in this case. If the frequency of a radio signal is found in step B-5 as well, reception is continued with the corresponding frequency band (B-6).

After this processing, the log table 33 of the memory 16 is updated with the currently detected frequency being set as the latest frequency, thus preparing the next operation. If the current radio signal is detected with the latest frequency in the log table 33 in this case, since the latest frequency has remained the same, the processing in step B-7 may be omitted.

In this embodiment, the frequencies used for previous communications are stored in the log table 33 in reverse chronological order. However, the present invention is not limited to this. For example, the number of times communication could be done with each frequency may be recorded, and the order in which the frequencies are stored in the table, i.e., the order of reception in steps B-3 and B-4, may be determined in accordance with the frequency of occurrence.

Still another embodiment of the present invention will be described next.

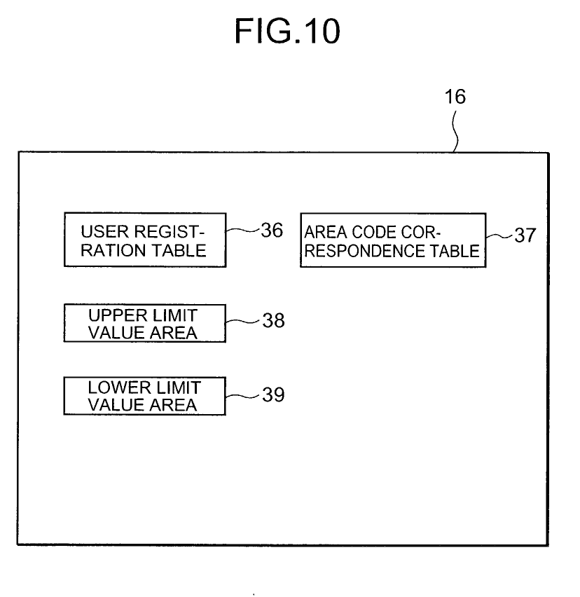

FIG. 10 is a view showing the arrangement of contents stored in the memory 16 in FIG. 3 in a mobile station according to the third embodiment of the present invention.

As shown in FIG. 10, in this embodiment, a user registration table 36, area code correspondence table 37, upper limit value area 38, and lower limit value area 39 are set in a memory 16.

In this embodiment, when, for example, the frequencies of radio signals from base stations are determined on an area basis, the processing time required to detect the frequency of a radio signal from a base station is shortened by registering areas where the user often visits.

In the user registration table 36, frequencies corresponding to the areas which the user registered in advance are stored in the order in which they were designated. Although the number of frequencies that can be stored need not be specified, this number may be set in advance in the manufacturing stage or the user may be allowed to determine it.

In the area code correspondence table 37, the correspondence between the respective areas and the frequencies used by base stations that cover the areas is stored.

In the upper limit value area 34, the upper limit frequency (2,167.6 MHz in this case) which can be an intermediate frequency specified in the mobile communication system is stored. In the lower limit value area 35, the lower limit frequency (2,112.4 MHz in this case) which can be an intermediate frequency specified in the mobile communication system is stored.

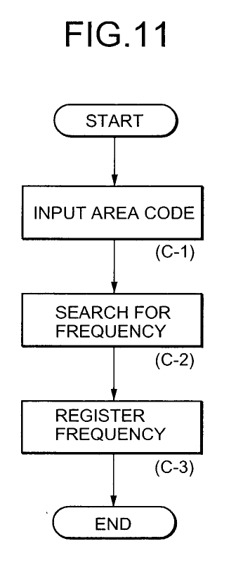

FIG. 11 is a flow chart showing the processing performed by a mobile station according to the third embodiment of the present invention, and more specifically, a flow chart showing registration processing with respect to the user registration table 36 in FIG. 10.

First of all, the user inputs area codes of places where he/she visits with high possibility by operating the operation input section of a peripheral circuit 17 (C-1). This input method may be a method of making the user directly input predetermined area codes, but may be a method of displaying area names to which a mobile station 1 corresponds on the display section of the peripheral circuit 17 and allowing the user to select some of the displayed area names in consideration of convenience for the user in input operation, or the like.

The mobile station 1 searches the area code correspondence table 37 on the basis of the area code input from the user, and obtains a frequency used when a base station in this area transmits a radio signal (C-2).

The frequency obtained in step C-2 is registered in the user registration table 36 (C-3). Note that the order in which the frequencies are arranged in the user registration table 36, i.e., the order in which the presence/absence of a radio signal is detected, may be the order in which the user has input the frequencies. Alternatively, the user may separately input a priority order, and the frequencies may be arranged in this priority order.

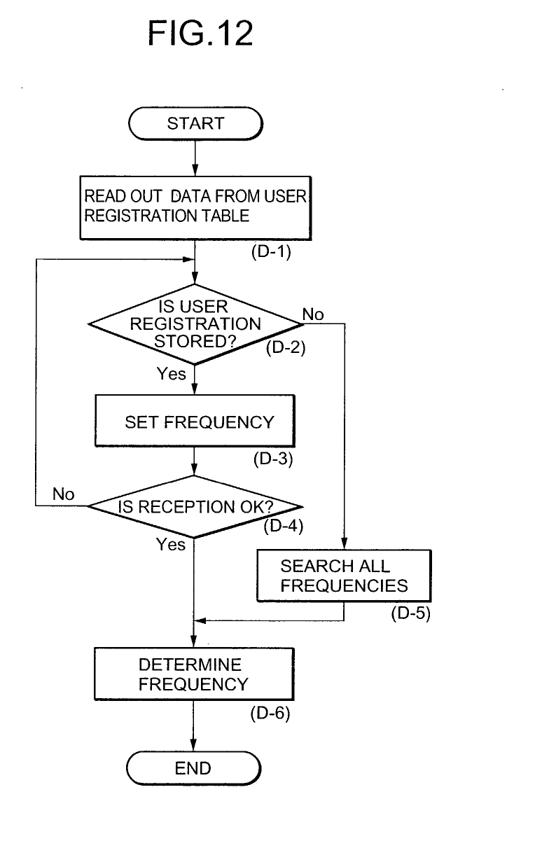

FIG. 12 is a flow chart showing the processing performed by the mobile station according to this present invention, and more specifically, the processing performed by the mobile station 1 to detect the frequency of a radio signal from a base station.

First of all, when it is necessary to find the frequency band of radio signals from a base station as in a case wherein the mobile station 1 is powered on, a CPU 15 reads out frequencies registered by the user from the user registration table 36 (D-1).

If no frequency relating to a user registration is stored in the user registration table 36 because, for example, the user has registered no frequency relating to the user registration (D-2), the flow advances to step D-5 to perform all frequency search (to be described later).

If it is determined in step D-2 that frequencies registered by the user are obtained, the CPU 15 indicates one of the frequencies which is located at the highest ordinal level to a synthesizer 23 of the radio section 12, and tries demodulation with this frequency (D-3). If a radio signal is detected (D-4), reception with the corresponding frequency band is continued (D-6).

If no radio signal is detected in step D-4, the flow returns to step D-2 to check whether there are any frequencies left unchecked among the frequencies registered by the user. If there are frequencies left unchecked among the frequencies registered by the user, the CPU 15 indicates one of the frequencies which is located at the highest ordinal level to the synthesizer 23 of the radio section 12, and tries demodulation with this frequency (D-3) If a radio signal is detected (D-4), reception with the corresponding frequency band is continued (D-6).

If it is determined in step D-2 that there is no unchecked frequency among the frequencies registered by the user, the flow advances to step D-5 as in the case wherein no log data is obtained.

In step D-5, as in step A-5 in FIG. 7, the CPU 15 reads out the upper and lower limit frequencies from the upper limit value area 38 and lower limit value area 39 of the memory 16, indicates frequencies in this range to the synthesizer 23 of the radio section 12 with increments of 0.2 MHz, and tries demodulation with these frequencies. This search is repeated until a radio signal is detected. Any search method, e.g., upward search or downward search, can be used in this case. If the frequency of a radio signal is found in step D-5 as well, reception is continued with the corresponding frequency band (D-6).

Note that the first and third embodiments may be combined with each other so that the frequency used when the mobile station 1 was connected to the previous base station and the frequencies registered by the user may be checked before other frequencies.

In addition, the second and third embodiments may be combined so that the frequency in the log data set when the mobile station 1 was connected to a base station in the past and the frequencies registered by the user may be checked before other frequencies.

Assume that the frequency of a radio signal from a base station differs depending on the carrier, and the mobile station 1 can be used under a plurality of carriers. In this case, as in the third embodiment in which the user registers areas, carriers that may be frequently used are registered in the mobile station 1 so that the mobile station 1 can check the frequencies assigned to these carriers with higher priority.

In each embodiment described above, the present invention is applied to the mobile communication system of the CDMA scheme. Obviously, however, the present invention is not limited to this, and can be applied to any other communication schemes such as the CDMA scheme.

In addition, the present invention can be applied to not only communication between a base station and a mobile station in a mobile communication system but also two radio communication apparatuses which communicate with each other with any one of a plurality of frequencies set in advance.

What is claimed is:

1. A mobile station in a mobile communication system in which a base station communicates with a mobile station in one of a plurality of set frequency bands,
wherein when a frequency band of a radio signal from a base station is to be detected, detection of a frequency band which was used in the past for actual communication with any of base stations is performed before detection of other frequency bands.

2. A mobile station according to claim 1, wherein the frequency band used in the past for actual communication with any of base stations is a frequency band that was used in immediately preceding communication.

3. A mobile station in a mobile communication system in which a base station communicates with a mobile station in one of a plurality of set frequency bands,
wherein when a frequency band of a radio signal from a base station is to be detected, detection of a predetermined frequency band is performed before detection of other frequency bands.

4. A mobile station according to claim 3, wherein the predetermined frequency band is set when a user registers the frequency band.

5. A mobile station in a mobile communication system in which a base station communicates with a mobile station in one of a plurality of set frequency bands, comprising an antenna which receives a radio signal from a base station, a radio section which extracts a component in a frequency band as a demodulation target of the radio signal received by said antenna, and a control section which indicates the frequency band as the demodulation target to said radio section,
wherein when said control section indicates a frequency band to said radio section to detect a frequency band used for communication with a current base station, said control section indicates, to said radio section, a frequency band which was used in the past for actual communication with any of base stations, of the plurality of set frequency bands, before indicating other frequency bands.

6. A mobile station in a mobile communication system in which a base station communicates with a mobile station in one of a plurality of set frequency bands, comprising an antenna which receives a radio signal from a base station, a radio section which extracts a component in a frequency band as a demodulation target of the radio signal received by said antenna, and a control section which indicates the frequency band as the demodulation target to said radio section,
wherein when said control section indicates a frequency band to said radio section to detect a frequency band used for communication with a current base station, said control section indicates, to said radio section, a predetermined frequency band of the plurality of set frequency bands before indicating other frequency bands.

7. A mobile station according to claim 6, wherein said control section comprises registration means for registering a predetermined frequency band, and means for, when a frequency band is to be indicated to said radio section to detect a frequency band to be used for communication with a current base station, indicating a frequency band, of the plurality of frequency bands, which is registered in said registration means before indicating other frequency bands.

8. A mobile station according to claim 7, wherein said mobile station further comprises input means for inputting predetermined information, and said registration means registers a frequency band corresponding to information input by said input means.

9. A mobile station in a mobile communication system in which a base station communicates with a mobile station in one of a plurality of set frequency bands, comprising an antenna which receives a radio signal from a base station, a radio section which extracts a component in a frequency band as a demodulation target of the radio signal received by said antenna, a control section which indicates the frequency band as the demodulation target to said radio section, and a nonvolatile storage section which stores a frequency band which was used in the past for actual communication with any of base stations,
wherein when said control section indicates a frequency band to said radio section to detect a frequency band used for communication with a current base station, said control section indicates, to said radio section, the frequency band of the plurality of frequency bands which is stored in said storage section, before indicating other frequency bands.

10. A mobile station in a mobile communication system in which a base station communicates with a mobile station in one of a plurality of set frequency bands, comprising an antenna which receives a radio signal from a base station, a radio section which extracts a component in a frequency band as a demodulation target of the radio signal received by said antenna, a control section which indicates the frequency band as the demodulation target to said radio section, and a nonvolatile storage section which stores a predetermined frequency band,
wherein when said control section indicates a frequency band to said radio section to detect a frequency band used for communication with a current base station, said control section indicates, to said radio section, the frequency band of the plurality of frequency bands which is stored in said storage section, before indicating other frequency bands.

11. A mobile station according to claim 10, wherein said control section detects whether a frequency band is stored in said storage section, when indicating a frequency band to said radio section to detect a frequency band used for communication with a current base station, controls said radio section to extract a component in a frequency band as a demodulation target with respect to the plurality of frequency bands when no frequency band is stored in said storage section, and causes said storage section to store the extracted frequency band.

12. A mobile station according to claim 9, wherein said mobile station further comprises input means for inputting predetermined information, and said storage section can store a frequency band corresponding to the information input by said input means as well as a frequency band used in the past for actual communication with any of base stations.

13. A mobile station according to claim 10, wherein said mobile station further comprises input means for inputting predetermined information, and said registration means registers a frequency band corresponding to information input by said input means.

14. A mobile station according to any one of claims 1 to 13, wherein said mobile communication system is based on a CDMA scheme.

15. A frequency band detection method of causing a mobile station in a mobile communication system in which a base station communicates with a mobile station in any of a plurality of set frequency bands to detect a frequency band of a radio signal from a base station,
wherein detection of a frequency band, of the plurality of set frequency bands, which was used in the past for actual communication with any of base stations is performed before detection of other frequency bands.

16. A frequency band detection method of causing a mobile station in a mobile communication system in which a base station communicates with a mobile station in any of a plurality of set frequency bands to detect a frequency band of a radio signal from a base station,
wherein detection of a predetermined frequency band of the plurality of set frequency bands is performed before detection of other frequency bands.
